(19) United States
(12) Patent Application Publication
(10) Pub. No.: US 2026/0310263 A1
(43) Pub. Date: Oct. 8, 2026

(54) Slidable Support for Mobile Phone Shell

(71) Applicant: Shenzhen Huichen Technology Co., Ltd, Guangdong (CN)

(72) Inventor: Bangzao ZHANG, Guangdong (CN)

(73) Assignee: Shenzhen Huichen Technology Co., Ltd, Guangdong (CN)

(21) Appl. No.: 19/098,308

(22) Filed: Apr. 2, 2025

(51) Int. Cl. G06F 1/16; H04M 1/02

(52) U.S. Cl. CPC G06F 1/166; H04M 1/0279

(57) ABSTRACT

The present disclosure provides a slidable support for a mobile phone shell, which comprises a track and a slider, as well as a flexible bracket connected to the slider. The track is provided with a guide groove, and the slider is at least partially located in the guide groove and is slidably connected to the guide groove. The track is provided with a first fitting surface, and the slider is provided with a second fitting surface. The first fitting surface and the second fitting surface are arranged facing each other.

### TECHNICAL FIELD

The present disclosure relates to the technical field of mobile phone supports, and particularly to a slidable support for a mobile phone shell.

### BACKGROUND

Nowadays, people's dependence on mobile phones is increasing day by day, and the usage scenarios of mobile phones have become more and more diverse. To meet the multi-scenario and multi-angle usage requirements of mobile phones, mobile phone shells with support functions that combine protection and support functions have appeared on the market to meet users'needs.

For example, the existing U.S. Pat. No. 11,405,067 discloses a “Holding apparatus and method for use with portable electronic devices utilizing a strip apparatus”. The support in this patent does not have a positioning function, and the support is prone to sliding during use, resulting in unstable support.

Therefore, there is a need to propose a new type of mobile phone shell support to solve the above-mentioned problems.

### SUMMARY

An object of the present disclosure is to provide a slidable support for a mobile phone shell to solve the above-mentioned problems in the prior art.

The present disclosure provides a slidable support for a mobile phone shell to solve the problems raised in the above background art.

In order to achieve the above-mentioned purpose of the disclosure, the following technical solutions are adopted in the present disclosure:

A slidable support for a mobile phone shell includes a track, a slider, and a flexible bracket connected to the slider, wherein the track is provided with a guide groove, and the slider is at least partially located in the guide groove and is slidably connected to the guide groove; and the track is provided with a first fitting surface, the slider is provided with a second fitting surface, and the first fitting surface and the second fitting surface are arranged facing each other; and the first fitting surface and the second fitting surface are respectively provided with elastic positioning assemblies and positioning parts, and a plurality of positioning parts or elastic positioning assemblies are provided and are arranged at intervals along a sliding direction of the slider; and the elastic positioning assembly is selectively engaged with any one of the positioning parts to keep the slider fixed on the track.

A slidable support for a mobile phone shell includes a track, a slider, and a flexible bracket connected to the slider, wherein the track is provided with a guide groove, and the slider is at least partially located in the guide groove and is slidably connected to the guide groove; and the surfaces of the track and the slider facing each other are respectively provided with a first fitting surface and a second fitting surface, wherein the first fitting surface and the second fitting surface are respectively provided with elastic positioning assemblies and positioning parts; and wherein a plurality of positioning parts or elastic positioning assemblies are provided and are arranged at intervals along a sliding direction of the slider; and the elastic positioning assembly comprises an installation cavity, an elastic member located in the installation cavity, and a bead; and wherein, the bead is pressed by the elastic member and partially protrudes from the installation cavity, and is able to form a snap-fit positioning with any of the positioning parts.

When in use, the first connecting part is pushed, and the first connecting part drives the slider to move in the guide groove. When the slider moves, the bead moves upward under the action of the first fitting surface and squeezes the elastic member, causing the bead to move into the interior of the installation cavity. When the first connecting part moves, it will drive the two intermediate parts to rotate relative to each other under the action of the bent part. After the first connecting part moves to the specified position, the bead will be reset under the action of the elastic member, causing the bead to snap into the interior of the positioning part to limit the movement of the slider. The mobile phone shell is supported by the flexible bracket, and the flexible bracket is positioned by the elastic positioning assembly to prevent the flexible bracket from moving during use and affecting the supporting function of the mobile phone shell.

### BRIEF DESCRIPTION OF DRAWINGS

The drawings, which form a part of this application, are used to provide a further understanding of the present disclosure. The schematic embodiments of the present disclosure and the descriptions thereof are used to explain the present disclosure and do not constitute an improper limitation of the present disclosure. In the drawings:

FIG. 1 shows a schematic structural diagram of an embodiment of the slidable support for a mobile phone shell according to the present disclosure; and

FIG. 2 shows a schematic structural diagram of the track, the slider, and the positioning part in FIG. 1;

FIG. 3 shows a schematic cross-sectional structural diagram of the slidable support for a mobile phone shell in FIG. 1;

FIG. 4 shows a schematic structural diagram of the slider, the second fitting surface, and the elastic positioning assembly in FIG. 2;

FIG. 5 shows a schematic cross-sectional structural diagram of the elastic positioning assembly in FIG. 4;

FIG. 6 shows a schematic structural diagram of the folded state of the track and the flexible bracket in FIG. 1;

FIG. 7 shows a schematic cross-sectional structural diagram of the track and the flexible bracket in FIG. 6;

FIG. 8 shows a schematic structural diagram of other embodiments of the slidable support for a mobile phone shell in FIG. 1.

In the figures, the above drawings include the following reference signs:

Track (100); Slider (200); Flexible bracket (300); First connecting part (301); Second connecting part (302); Intermediate part (303); Bent part (304); Cardboard (305); Guide groove (400); First fitting surface (500); Second fitting surface (600); Positioning part (700); Elastic positioning assembly (800); Installation cavity (801); Elastic member (802); Bead (803); Installation port (900).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

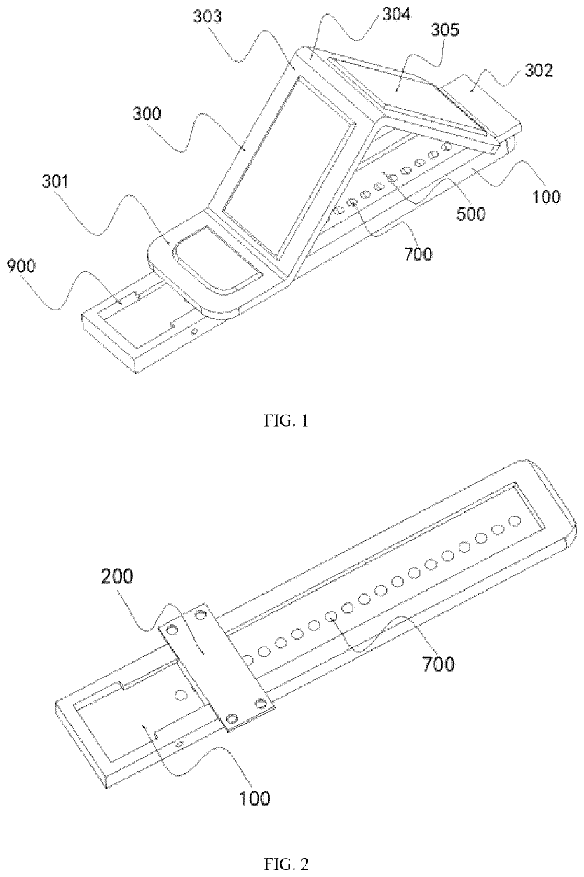

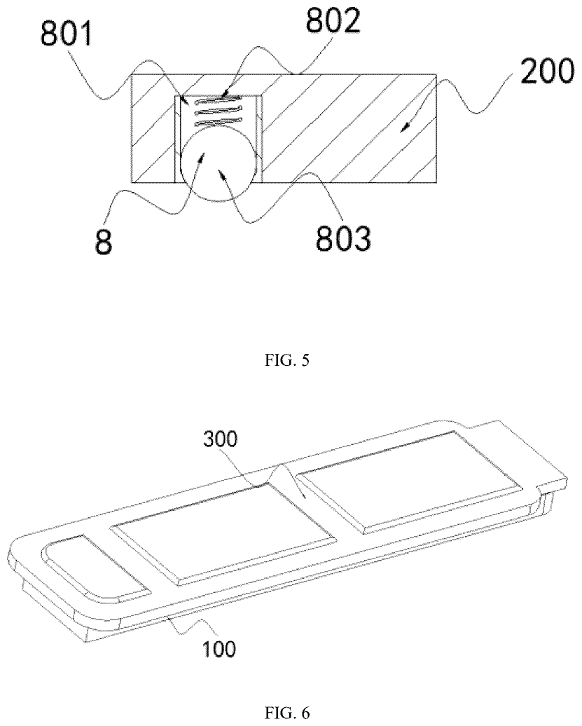

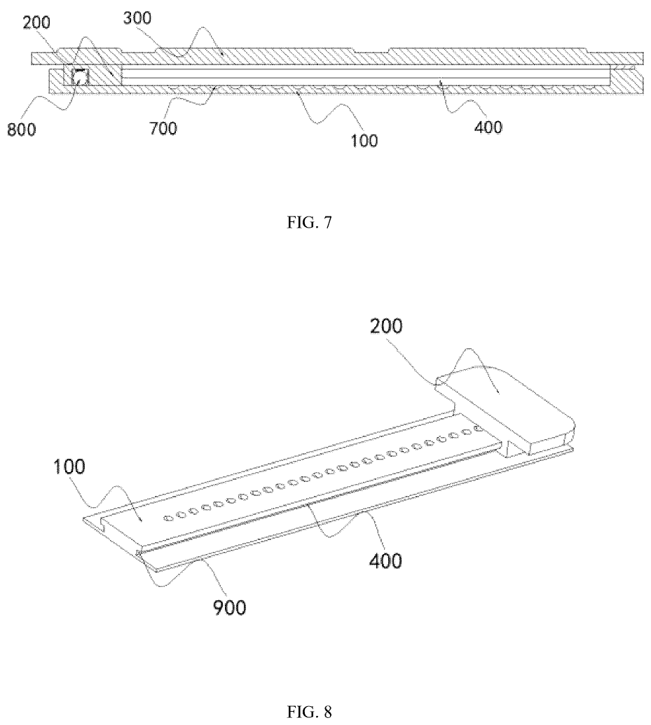

As shown in FIGS. 1 to 7, the present disclosure provides a slidable support for a mobile phone shell, which includes a track 100, a slider 200, and a flexible bracket 300 connected to the slider 200. The flexible bracket 300 has two states: flattened and folded. The track 100 is provided with a guide groove 400. The slider 200 is at least partially located in the guide groove 400 and is slidably connected to the guide groove 400. When the slider 200 slides in the guide groove 400, the state of the flexible bracket 300 is adjusted. The track 100 is provided with a first fitting surface 500, and the slider 200 is provided with a second fitting surface 600. The first fitting surface 500 and the second fitting surface 600 are arranged facing each other. The first fitting surface 500 and the second fitting surface 600 are respectively provided with elastic positioning assemblies 800 and positioning parts 700. A plurality of positioning parts 700 are arranged at intervals along the sliding direction of the slider 200. The elastic positioning assembly 800 can be selectively engaged with any positioning part 700 to keep the slider 200 fixed on the track 100.

Please refer to FIG. 8. In other embodiments, the track 100 has a convex structure. The slider 200 is sleeved on the outside of the track 100 and slides. The guide groove 400 is provided on the outside of the track 100. The slider 200 at least partially wraps the track 100 and is slidably connected to the guide groove 400. The convex-structured track 100 makes it easier to install and disassemble the slider 200, which is more convenient for users to operate. The slider 200 wraps the outside of the track 100, with a larger contact area and higher stability during sliding.

In other embodiments (not shown), the track 100 and the slider 200 are made of high-strength aluminum alloy materials to ensure the durability and stability of the support. The aluminum alloy material is lightweight, corrosion-resistant, and has good mechanical properties, which is suitable for parts that slide frequently. In addition, the surface of the track 100 is anodized to increase its wear resistance and corrosion resistance and extend the service life of the support.

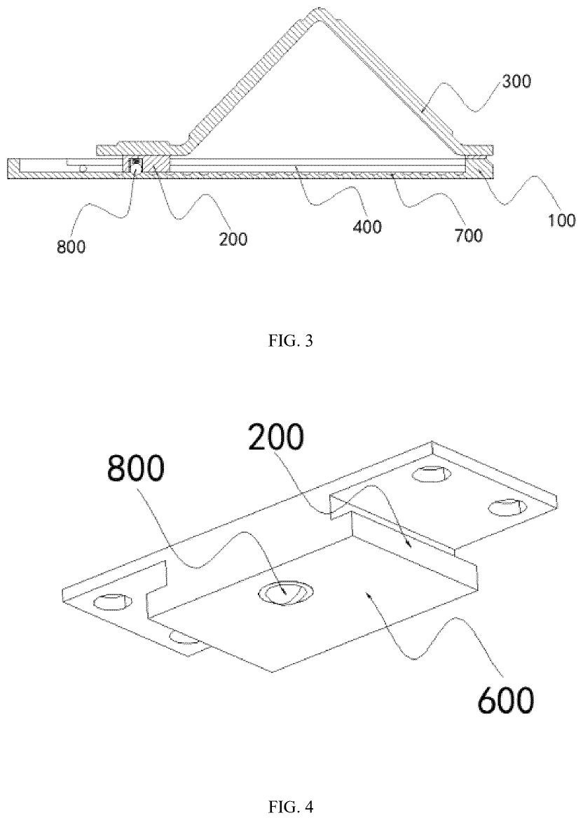

Please refer to FIGS. 3 to 5. In this embodiment, the elastic positioning assembly 800 includes an installation cavity 801, an elastic member 802, and a bead 803. The bead 803 is arranged in the installation cavity 801. The elastic member 802 is installed between the groove bottom of the installation cavity 801 and the bead 803 to provide support force for the bead 803 through the elastic member 802.

The installation cavity 801 is provided on the second fitting surface 600 of the slider 200. The bead 803 is pressed by the elastic member 802 and partially protrudes from the installation cavity 801, and can be engaged with any arc-shaped groove. The elastic member 802 provides support for the bead 803, so that the bead 803 protrudes outside the installation cavity 801 and snaps into the arc-shaped groove to position the slider 200, ensuring that the flexible bracket 300 does not slide during the use of the flexible bracket 300 for the mobile phone shell, which would otherwise affect the supporting function for the mobile phone shell.

A limiting part is provided inside the installation cavity 801. The limiting part prevents the bead 803 from completely separating from the slider 200, ensuring that the bead 803 can move within the installation cavity 801.

In other embodiments (not shown), the elastic positioning assembly 800 can use a magnetic positioning system to replace the traditional mechanical positioning system. Specifically, a plurality of magnetic points are set on the first fitting surface 500 of the track 100, and corresponding magnetic elements are set on the second fitting surface 600 of the slider 200. Through magnetic adsorption, the slider 200 can be stably positioned on the track 100, and it is convenient for users to make fine adjustments. This magnetic positioning system has the advantages of no wear, low noise, and long service life.

Please refer to FIGS. 1 to 3. In this embodiment, the positioning part 700 is an arc-shaped groove and is provided on the first fitting surface 500 of the track 100. A plurality of arc-shaped grooves are provided and arranged in sequence along the sliding direction of the slider 200. By setting a plurality of arc-shaped grooves, the position of the slider 200 can be adjusted as needed, enabling the slider 200 to better adjust the angle of the flexible bracket 300, which is beneficial for the angle adjustment of the mobile phone shell.

In other embodiments (not shown), the positioning part 700 and the elastic positioning assembly 800 can be interchanged. The elastic positioning assembly 800 can be set on the track 100, and the positioning part 700 can be set on the slider 200. Setting the elastic positioning assembly 800 on the track 100 can reduce the complexity and volume of the slider 200, making the slider 200 lighter and more convenient for users to operate. The slider 200 only needs to be provided with a simple arc-shaped groove (positioning part 700), which reduces the manufacturing difficulty and cost.

In other embodiments (not shown), the elastic positioning assembly 800 (including the installation cavity 801, the elastic member 802, and the bead 803) is installed on the side of the track 100 or the slider 200. The bead 803 partially protrudes from the side under the action of the elastic member 802 and can be engaged with the positioning part 700 on the other component (the slider 200 or the track 100). The elastic positioning assembly 800 and the positioning part 700 set on the side can better disperse the force and improve the stability of the bracket when subjected to lateral force.

In another embodiment (not shown), a plurality of positioning parts 700 are provided on the side of the slider 200 or the track 100. The positioning parts 700 are arranged at intervals along the sliding direction. When the slider 200 slides on the track 100, the elastic positioning assembly 800 provided on the side can selectively engage with the positioning parts 700 to achieve positioning. The elastic positioning assembly 800 and the positioning parts 700 provided on the side can better disperse the force and improve the stability of the bracket when subjected to lateral force.

Please refer to FIGS. 1 to 4. In this embodiment, the track 100 is provided with an installation port 900. The installation port 900 is communicated with the guide groove 400. The slider 200 can slide into the installation port 900 and can disengage from the guide groove 400 through the installation port 900. The slider 200 can be installed inside the track 100 through the installation port 900, allowing the slider 200 to move in the guide groove 400.

In other embodiments (not shown), the guide groove 400 of the track 100 is coated with a self-lubricating coating, and the surface of the slider 200 is also specially treated to reduce the frictional resistance during sliding. This design not only makes the sliding smoother but also reduces wear and extends the service life of the bracket. In addition, the self-lubricating coating also has the functions of dust and dirt prevention, keeping the bracket clean.

In other embodiments (not shown), the installation port 900 of the track 100 is provided with an anti-drop buckle. When the slider 200 slides into the installation port 900, the anti-drop buckle will automatically lock to prevent the slider 200 from accidentally falling off during use. This design increases the safety of the bracket and ensures that the mobile phone will not be damaged due to the falling off of the bracket during use.

Please refer to FIGS. 1 and 2. In this embodiment, the flexible bracket 300 includes a first connecting part 301, a second connecting part 302, and an intermediate part 303 located between the first connecting part 301 and the second connecting part 302.

The first connecting part 301 is attached to the slider 200. Through the movement of the slider 200, the first connecting part 301 is driven to move together. The second connecting part 302 is used for connecting to the mobile phone shell.

At least two intermediate parts 303 are provided. A bendable bent part 304 is provided between two adjacent intermediate parts 303. Two adjacent intermediate parts 303 can be bent through the bent part 304. When the slider 200 drives the first connecting part 301 to move, it will drive the two intermediate parts 303 to bend through the bent part 304, adjusting the angle between the two intermediate parts 303 to conveniently adjust the mobile phone shell to a suitable angle for use.

The intermediate part 303 is filled with a cardboard 305. The intermediate part 303 is kept straight through the cardboard 305. The cardboard 305 ensures that the intermediate part 303 remains in a straight state and will not bend due to the movement of the first connecting part 301, which would otherwise affect the support of the mobile phone shell.

In other embodiments (not shown), the surface of the flexible bracket 300 is covered with a non-slip silicone layer. The non-slip silicone layer not only provides a good hand feel but also increases the friction between the mobile phone shell and the bracket, preventing the mobile phone from slipping during use. In addition, the silicone layer also has the characteristics of anti-fouling and easy cleaning, which is convenient for users'daily maintenance.

In other embodiments (not shown), a plurality of bent parts 304 are provided between the intermediate parts 303 of the flexible bracket 300, and each bent part 304 can be independently adjusted in angle. Through this design, users can adjust the mobile phone shell to a plurality of different angles according to their needs to meet the requirements of different usage scenarios. For example, when watching videos, the mobile phone shell can be adjusted to a larger angle; when reading, the mobile phone shell can be adjusted to a smaller angle.

In other embodiments (not shown), the second connecting part 302 of the flexible bracket 300 is provided with a quick-release button. Users only need to press the button to quickly remove the mobile phone shell from the bracket. The support is not limited to being used for mobile phone shells but can also be used for tablet computer protective cases, mobile phone card holders, etc.

From the above description, it can be seen that the above embodiments of the present disclosure achieve the following technical effects: when in use, the first connecting part 301 is pushed, and the first connecting part 301 drives the slider 200 to move in the guide groove 400; when the slider 200 moves, the bead 803 moves upward under the action of the first fitting surface 500 and squeezes the elastic member 802, causing the bead 803 to move into the interior of the installation cavity 801; when the first connecting part 301 moves, it will drive the two intermediate parts 303 to rotate relative to each other under the action of the bent part 304; after the first connecting part 301 moves to the specified position, the bead 803 will be reset under the action of the elastic member 802, causing the bead 803 to be snapped into the interior of the positioning part 700 to limit the position of the slider 200; the mobile phone shell is supported by the flexible bracket 300, and the flexible bracket 300 is positioned by the elastic positioning assembly 800 to prevent the flexible bracket 300 from moving during use, which otherwise would affect the supporting effect of the mobile phone shell.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A slidable support for a mobile phone shell, comprising a track, a slider, and a flexible bracket connected to the slider, wherein
the track is provided with a guide groove, and the slider is at least partially located in the guide groove and is slidably connected to the guide groove; and
the track is provided with a first fitting surface, the slider is provided with a second fitting surface, and the first fitting surface and the second fitting surface are arranged facing each other; and
the first fitting surface and the second fitting surface are respectively provided with elastic positioning assemblies and positioning parts, and a plurality of positioning parts or elastic positioning assemblies are provided and are arranged at intervals along a sliding direction of the slider; and
the elastic positioning assembly is selectively engaged with any one of the positioning parts to keep the slider fixed on the track.

2. The slidable support for a mobile phone shell according to claim 1, wherein the elastic positioning assembly comprises an installation cavity, an elastic member, and a bead, wherein the bead is arranged in the installation cavity, and the elastic member is installed between a groove bottom of the installation cavity and the bead.

3. The slidable support for a mobile phone shell according to claim 2, wherein the installation cavity is provided on the second fitting surface of the slider.

4. The slidable support for a mobile phone shell according to claim 3, wherein the positioning parts are an arc-shaped grooves and are provided on the first fitting surface of the track, and a plurality of arc-shaped grooves are provided and are arranged in sequence along the sliding direction of the slider.

5. The slidable support for a mobile phone shell according to claim 4, wherein the bead is pressed by the elastic member and partially protrudes from the installation cavity, and is engaged with any one of the arc-shaped grooves.

6. The slidable support for a mobile phone shell according to claim 1, wherein the track is provided with an installation port, and the installation port is communicated with the guide groove.

7. The slidable support for a mobile phone shell according to claim 6, wherein the slider is able to slide into the installation port and be separated from the guide groove through the installation port.

8. The slidable support for a mobile phone shell according to claim 1, wherein the flexible bracket comprises a first connecting part and a second connecting part, as well as an intermediate part located between the first connecting part and the second connecting part.

9. The slidable support for a mobile phone shell according to claim 8, wherein the first connecting part is attached to the slider, and the second connecting part is configured for connecting to the mobile phone shell.

10. The slidable support for a mobile phone shell according to claim 8, wherein at least two intermediate parts are provided, a bendable bent part is provided between two adjacent intermediate parts, and two adjacent intermediate parts are bendable through the bent part.

11. The slidable support for a mobile phone shell according to claim 10, wherein the intermediate part is filled with a cardboard, and the intermediate part is kept straight by the cardboard.

12. A slidable support for a mobile phone shell, comprising a track, a slider, and a flexible bracket connected to the slider, wherein
the track is provided with a guide groove, and the slider is at least partially located in the guide groove and is slidably connected to the guide groove; and
the surfaces of the track and the slider facing each other are respectively provided with a first fitting surface and a second fitting surface, wherein the first fitting surface and the second fitting surface are respectively provided with elastic positioning assemblies and positioning parts; and wherein a plurality of positioning parts or elastic positioning assemblies are provided and are arranged at intervals along a sliding direction of the slider; and
the elastic positioning assembly comprises an installation cavity, an elastic member located in the installation cavity, and a bead; and
wherein, the bead is pressed by the elastic member and partially protrudes from the installation cavity, and is able to form a snap-fit positioning with any of the positioning parts.

13. The slidable support for a mobile phone shell according to claim 12, wherein the installation cavity is provided on the second fitting surface, the positioning parts are arc-shaped grooves and are provided on the first fitting surface, and a plurality of arc-shaped grooves are provided and are arranged in sequence along the sliding direction of the slider.

14. The slidable support for a mobile phone shell according to claim 12, wherein the track is provided with an installation port, and the installation port is communicated with the guide groove; and
the slider is able to slide into the installation port and be disengaged from the guide groove through the installation port.

15. The slidable support for a mobile phone shell according to claim 12, wherein the flexible bracket comprises a first connecting part connected to the slider, a second connecting part for connecting to the mobile phone shell, and at least two intermediate parts located between the first connecting part and the second connecting part.

16. The slidable support for a mobile phone shell according to claim 15, wherein a bendable bent part is provided between two adjacent intermediate parts, and two adjacent intermediate parts can be bent through the bent part.

17. The slidable support for a mobile phone shell according to claim 16, wherein the intermediate part is filled with a cardboard, and the intermediate part is kept straight by the cardboard.

18. The slidable support for a mobile phone shell according to claim 15, wherein the first connecting part and/or the second connecting part is filled with the cardboard, and the first connecting part and/or the second connecting part is kept straight through the cardboard.
